(19) United States
(12) Patent Application Publication
(10) Pub. No.: US 2023/0392028 A1
(43) Pub. Date: Dec. 7, 2023

(54) POLYURETHANE COATING COMPOSITION

(71) Applicant: SWIMC LLC, Cleveland, OH (US)

(72) Inventors: Nathan McCORMICK, Minneapolis, MN (US); David J. FOUQUETTE, Minneapolis, MN (US)

(21) Appl. No.: 18/331,297

(22) Filed: Jun. 8, 2023

Related U.S. Application Data
(63) Continuation of application No. 16/683,688, filed on Nov. 14, 2019, now abandoned.
Application No. 16/683,688 is a continuation of application No. PCT/US2018/033369, filed on May 18, 2018.
(60) Provisional application No. 62/508,476, filed on May 19, 2017.

(51) Int. Cl. C09D 7/80; C09D 7/20; C08G 18/22; C08G 18/24; C09D 175/04

(52) U.S. Cl. CPC C09D 7/80; C09D 7/20; C08G 18/222; C08G 18/246; C09D 175/04

(57) ABSTRACT

Methods of making a two-component composition that can be applied to a substrate and cured to provide a coating that demonstrates minimal solvent pop at the dry film thickness limit of the coating are provided. A cured coating made from the two-component composition demonstrates minimal solvent pop, minimal air entrapment, and optimal dry spray and overspray acceptance. Coated articles made using the methods described herein are also provided

### BACKGROUND OF THE INVENTION

Coating compositions are applied to a variety of substrates for a variety of uses, and may be used for both protective and aesthetic purposes. Such coatings need to be applied quickly and efficiently.

To increase the productivity of a painting operation, it is typical to apply coatings in two coats at higher dry film thickness than for most coating operations where paint is applied in multiple layers. Moreover, these coatings are sometimes applied in a wet-on-wet manner.

Sometimes these coating demonstrate poor appearance on curing and exhibit certain surface defects, including solvent pop, dry spray, and the like. This is believed to be because the coating cures too quickly and cannot flow or level out to overcome defects formed during application and/or curing. Methods designed to slow down the rate of cure are not always effective and may have a negative impact on the performance characteristics of the cured coating.

From the foregoing, it will be appreciated that there is a need to balance the rate of cure with appearance and performance properties of the coating. In particular, there is a need to reduce solvent pop, dry spray, and the like during application and/or curing of a coating composition applied to a substrate.

### SUMMARY

The present invention provides methods of making a two-component composition that can be applied to a substrate and cured to provide a coating that demonstrates minimal solvent pop at the dry film thickness limit of the coating. The two-component composition also demonstrates minimal air entrapment, and optimal dry spray and overspray acceptance. Coated articles made using the methods described herein are also provided.

In one embodiment, the method described herein includes steps of providing a first component of a coating composition, and providing a reaction mixture that includes two or more solvents, and a catalyst. The first component is then combined with the reaction mixture, and the combination is mixed with a second component to form a two-component composition. The composition is applied to a substrate and cured at temperatures of about 25° C. (77 F) to 160° C. (320 F) to form a cured coating. The cured coating demonstrates minimal solvent pop at the dry film thickness limit of the coating.

In another embodiment, the method described herein includes steps of providing a first component of a coating composition. The first component includes a reaction mixture that includes two or more solvents, and a catalyst. The first component is combined with a second component to form a two-component composition. The composition is applied to a substrate and cured at temperatures of room temperature about 25° C. (77 F) to 160° C. (320 F) to form a cured coating. The cured coating demonstrates minimal solvent pop at the dry film thickness limit of the coating.

The above summary of the present invention is not intended to describe each disclosed embodiment or every implementation of the present invention. The description that follows more particularly exemplifies illustrative embodiments. In several places throughout the application, guidance is provided through lists of examples, which can be used in various combinations. In each instance, the recited list serves only as a representative group and should not be interpreted as an exclusive list.

The details of one or more embodiments of the invention are set for in the accompanying drawings and the description below. Other features, objects, and advantages of the invention will be apparent from the description and drawings, and from the claims.

### Selected Definitions

Unless otherwise specified, the following terms as used herein have the meanings as provided below.

The term “component” refers to any compound that includes a particular feature or structure. Examples of components include compounds, monomers, oligomers, polymers, and organic groups contained there.

The term “double bond” is non-limiting and refers to any type of double bond between any suitable atoms (e.g., C, O, N, etc.).

The term “triple bond” is non-limiting and refers to any type of triple bond between any suitable atoms.

Unless otherwise indicated, a reference to a “(meth)acrylate” compound (where “meth” is bracketed) is meant to include both acrylate and methacrylate compounds.

The term “polycarboxylic acid” includes both polycarboxylic acids and anhydrides thereof.

The term “polyol” refers to a polymer with two or more hydroxyl (—OH) groups. As used herein, the term may refer to different types of polyols, including, for example, polyether polyols, polyester polyols, and the like.

The term “solvent pop” refers to the appearance of small bubbles visible to the eye that occur on the surface of a coated substrate as solvent evaporates from the coating. The term may also refer to small craters formed on the surface when a bubble pops, but the coating cannot flow and level out to a smooth appearance. The term “solvent pop resistant coating” refers to a coating wherein no bubbles or craters are visible to eye at the dry film thickness limit of the coating. The terms “solvent pop resistant coating” and “minimal solvent pop” are used interchangeably herein.

As used herein, the term “dry film thickness limit” of a coating refers to the maximum film build of a coating on a substrate for a given application. As described herein, the dry film thickness limit is typically about 150 μm (approximately 6.0 mil). For applications beyond the scope of the description herein, dry film thickness limits may vary according to end use or application.

The term “dry spray,” as used herein, refers to a coating surface defect or failure characterized by a dull surface with a dull appearance and rough, sand-paper-like texture. The problem usually occurs when solvent evaporates too quickly and the coating cures too quickly. The term “dry spray acceptance” refers to the minimal amount of dry spray that is acceptable for a given painted substrate or target, and is typically expressed in terms of 20° or 60° gloss. The actual dry spray acceptance varies according to end use or application. The terms “dry spray” and “overspray” are used interchangeably herein.

As used herein, the term “air entrapment” refers to the formation of air bubbles on the surface and in the interior of a coating film. Air entrapment is affected by the method of application as well as the physical properties (including viscosity) of the coating composition. Air entrapment may also be affected by the ability of the film to release entrapped air before the coating film is fully cured.

The term “on”, when used in the context of a coating applied on a surface or substrate, includes both coatings applied directly or indirectly to the surface or substrate. Thus, for example, a coating applied to a primer layer overlying a substrate constitutes a coating applied on the substrate.

Unless otherwise indicated, the term “polymer” includes both homopolymers and copolymers (i.e., polymers of two or more different monomers).

The term “comprises” and variations thereof do not have a limiting meaning where these terms appear in the description and claims.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. Thus, for example, a coating composition that comprises “an” additive can be interpreted to mean that the coating composition includes “one or more” additives.

Also herein, the recitations of numerical ranges by endpoints include all numbers subsumed within that range (e.g., 1 to 5 includes 1, 1.5, 2, 2.75, 3, 3.80, 4, 5, etc.). Furthermore, disclosure of a range includes disclosure of all subranges included within the broader range (e.g., 1 to 5 discloses 1 to 4, 1.5 to 4.5, 1 to 2, etc.).

### DETAILED DESCRIPTION

The present description provides methods of making a two-component composition that can be applied to a substrate and cured to provide a coating that demonstrates minimal solvent pop at the dry film thickness limit of the coating. The two-component composition also demonstrates minimal air entrapment, and optimal dry spray and/or overspray acceptance. Coated articles made using the methods described herein are also provided.

The present description provides a method for coating a substrate with a two-component composition, preferably a two-component polyurethane composition. The method includes providing a first component of a coating composition and a second component of the coating composition. In an aspect, the second component is selected such that it is capable of reacting with the first component. The method further includes combining the first component, or the first and second component, with a reaction mixture including one or more solvents and a catalyst.

The methods described herein include providing a first component of a coating composition, preferably a polyurethane composition. In an embodiment, the first component is selected such that it is capable of reacting with a given second component. In an aspect, the first component is an isocyanate-reactive species or compound.

Suitable isocyanate-reactive components include those containing active hydrogen groups or active basic groups neutralized with an acid such as for example, aliphatic, cycloaliphatic and heterocyclic amino alcohols, diols, triols, amines, diamines, triamines, tetramines and amides. Other suitable isocyanate-reactive compounds also include for example, organic acids such as formic acid and acetic acid, inorganic acids such as hydrochloric acid and sulfuric acid, and ethylenically unsaturated monomers and their derivatives, such as polyacrylates, for example. In an aspect, the isocyanate-reactive component described herein is preferably a polyol. In some embodiments, polyols are used that have a number average molecular weight (Mn) of at least about 500, more preferably about 650 to 3000, and even more preferably about 1500 to 2000. Unless otherwise indicate, molecular weight, including weight average and/or number average molecular weight is determined by gel permeation chromatography (GPC), also known as size exclusion chromatography (SEC).

In an embodiment, the polyol described herein may be the product of the reaction of one or more acid or diol components. Suitable acids include, without limitation, aliphatic and aromatic monocarboxylic and dicarboxylic acids, saturated and/or unsaturated fatty acids, and the like. In an aspect, aliphatic acids used in the preparation of the polyol described herein include monocarboxylic acids, such as, for example, acetic acid, butanoic acid, hexanoic acid, acrylic acid, methacrylic acid, 2-ethyl hexanoic acid, cyanoacrylic acid, crotonic acid, dodecanoic acid, fatty acid dimers, and the like. In another aspect, aliphatic acids used in the preparation of the polyol described herein include dicarboxylic acids such as, for example, succinic acid, glutaric acid, adipic acid, azelaic acid, suberic acid, sebacic acid, decane di-acid, dodecane di-acid, abietic acid, acid dimers, and the like. The aliphatic acids may be straight-chain or branched acids. In yet another aspect, aromatic acids used in the preparation of the polyol described herein include aromatic monocarboxylic acids, such as, without limitation, alkyl substituted aromatic acids, alkenyl substituted aromatic acids, or hydroxy substituted aromatic acids. Examples include benzoic acid, hydroxy benzoic acid, cinnamic acid, and the like. In another aspect, aromatic acids include dicarboxylic acids such as, for example, isophthalic acid, terephthalic acid, phthalic acid, naphthalene dicarboxylic acid, 1,4-cyclohexane dicarboxylic acid (CHDA), oxy dibenzoic acid and the like.

In an embodiment, the polyol described herein may be derived from a diol. Suitable diols used in the preparation of the polyol described herein include, without limitation, aliphatic diols selected from unsubstituted or alkyl-substituted aliphatic diols. Examples include, without limitation, ethylene glycol, diethylene glycol, triethylene glycol, 1,2-propanediol, 1,3-propanediol, 1,2-butanediol, 1,3-butanediol, 1,4-butanediol, pentanediol, hexanediol, trimethylol propane, glycerol, and the like. In an embodiment, an unsubstituted diol, preferably 1,4-butanediol, is used.

The methods described herein include providing a second component of a coating composition. In an embodiment, the second component is selected such that it is capable of reacting with a given first component. In an aspect, the second component is an isocyanate-functional species or component.

Suitable isocyanate-functional compounds include, without limitation, blocked or unblocked aliphatic, cycloaliphatic or aromatic di-, tri-, or poly-valent isocyanates, such as hexamethylene diisocyanate, isophorone diisocyanate and the like. Further non-limiting examples of generally suitable unblocked or blocked isocyanates include isomers of isophorone diisocyanate, dicyclohexylmethane diisocyanate, toluene diisocyanate, diphenylmethane diisocyanate, phenylene diisocyanate, tetramethyl xylene diisocyanate, xylylene diisocyanate, and mixtures thereof. In some embodiments, isocyanates are used that have a number average molecular weight (Mn) of at least about 300, more preferably about 650 to 1000, and even more preferably about 500 to 700.

The methods described herein include a step of providing a reaction mixture to be combined with the first component prior to reaction with the second component. Alternatively, the reaction mixture may be present concurrently with the first and second component. In the methods described herein, the reaction mixture includes at least a mixture of two or more solvents, and a catalyst. Without limiting to theory, it is believed that the use of the reaction mixture described herein provides improved application properties, cure properties, and improved appearance to the ultimate cured coating, because the reaction mixture of two or more solvents inhibits early cure of the coating composition, i.e. the composition does not cure before all the solvent has evaporated. This results in a coating with minimal solvent pop, optimal dry spray or overspray acceptance, and minimal air entrapment.

In an embodiment, the reaction mixture described herein includes a mixture of two or more solvents. The solvents are in addition to any solvents typically used in the formulation of a coating or paint composition. In an aspect, at least one of the solvents in the reaction mixture present is water. Where water is used, water may be present at about 10%, preferably 20%, more preferably 50%, even more preferably 60% or more, but preferably no more than about 75%.

In an embodiment, the reaction mixture described herein includes a mixture of two or more solvents, a first solvent and a second solvent. In an aspect, the first and second solvent may each independently be a solvent typically used in the formulation of a coating or paint composition. For example, the first solvent may be ethyl acetoacetate (EAA) while the second solvent may be acetone. The first and second solvents may be present in a relative percent ratio of 80/20, preferably 60/40, 50/50, 40/60 or 20/80.

In an embodiment, the reaction mixture described herein includes a mixture of two or more solvents where at least one solvent is a compound with at least one alpha-hydrogen. Suitable examples of components having alpha-hydrogen include, without limitation, carboxylic acids, nitro-substituted compounds, amides, aldehydes, ketones, esters, nitriles, and the like.

In an aspect, the compound with at least one alpha-hydrogen may be a bidentate ligand capable of chelation with a metal catalyst or metal-containing species. Without limiting to theory, it is believed that solvent oxygen in the reaction mixture of two or more solvents chelates with a metal catalyst or metal-containing species and thereby prevents early or premature cure of the coating composition.

In another aspect, the compound with at least one alpha-hydrogen may be a compound having an active methylene group. Suitable examples include, without limitation, beta-keto esters, beta-diketone compounds, beta-dicarbonyl compounds, alpha-hydroxy ketones, fused beta-hydroxy ketones, beta-hydroxy nitrogen-fused heterocyclic aromatic compounds, and mixtures and combinations thereof.

In a preferred aspect, the reaction mixture of two or more solvents includes at least one beta-dicarbonyl compound, preferably a beta-diketo ester of a carboxylic acid, more preferably an acetoacetate compound. Suitable examples of beta-diketo esters include, without limitation, methyl acetoacetate, alpha-methyl-ethyl acetoacetate, alpha-n-butyl ethylacetoacetate, alpha-sec-butyl ethyl acetoacetate, alpha ethyl methyl acetoacetate, alpha-ethyl ethyl acetoacetate, and the like, as well as mixtures and combinations thereof. In a preferred aspect, at least one of the solvents in the reaction mixture is ethyl acetoacetate (EAA).

In an embodiment, the reaction mixture of two or more solvents includes east one compound having the structure of a compound of formula (I):

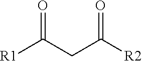

In the compound of formula (I), R1 and R2 are each independently H, C1-C10 alkyl, C1-C10 alkoxy, substituted C₁-C10 alkyl, substituted C₁-C10 alkoxy, and combinations thereof. In a preferred aspect, the reaction mixture of two or more solvents includes at least one compound having the structure of a compound of formula (I), wherein R1 is C₁-C10 alkyl, preferably —CH₃, and R2 is C₁-C10 alkoxy, preferably —OCH₃. In a preferred aspect, the compound of formula (I) is ethyl acetoacetate (EAA).

The compound of formula (I) may be present in a variety of three-dimensional conformations. In an aspect, the conformation may be where the two carbon-oxygen double bonds in formula (I) are oriented in the same plane. Without limiting to theory, it is believed that when the two carbon-oxygen double bonds are oriented in the same plane, the compound of formula (I) shows maximum binding affinity as a bidentate ligand for chelating to a metal.

In an embodiment, the reaction mixture of two or more solvents includes at least one beta-dicarbonyl compound, preferably ethyl acetoacetate (EAA). In an aspect, EAA is present at amounts of up to about 30%, preferably 1 to 25%, more preferably 10 to 20%, and most preferably, 5 to 10%, based on the total weight of the composition.

In an embodiment, the reaction mixture described herein includes at least one catalyst. Suitable examples of catalysts that may be part of the reaction mixture include, without limitation, metal, metal alkoxide, metal salts of aliphatic carboxylic acids, metal salts of alicyclic carboxylic acids, and mixtures or combinations thereof. In an aspect, the catalyst is a metal salt, preferably a tin or zinc salt. In a more preferred aspect, the catalyst is zinc octonoate or dibutyl tin dilaurate. In an aspect, the catalyst is present at an amount of about

0.001% to 1%, preferably 0.05 to 0.75 wt %, more preferably, 0.1 to 0.5 wt %, based on the total weight of resin solids.

The present description provides methods of making a two-component coating composition that will demonstrate optimal solvent pop resistance, dry spray acceptance, and other optimal performance or appearance characteristics. In an aspect, the method includes a first component. As described above, the first component is a polymeric resin component. In an aspect, the first component is mixed with a reaction mixture. The reaction mixture includes a mixture of two or solvents, and a catalyst. The combination of the reaction mixture and the first component is then combined with the second component and allowed to react to produce a two-component coating composition. When applied on a substrate and cured, the coating shows optimal solvent pop resistance at the dry film thickness limit of the coating.

In an embodiment, the methods described herein include a first component. The first component includes a reaction mixture. The reaction mixture includes a mixture of two or solvents, and a catalyst. The first component is then combined with the second component and allowed to react to produce a two-component coating composition. When applied on a substrate and cured, the coating shows optimal solvent pop resistance at the dry film thickness limit of the coating.

In an embodiment, the methods described herein include the step of curing a coating after it has been applied to a substrate surface. The coating is typically cured or hardened in a heated temperature environment, although curing at ambient or room temperatures is also possible. In a preferred aspect, the coating composition is cured at temperatures from room temperature of 25° C. (77 F) to about 160° C. (320 F), preferably from 100° C. to 140° C. (approx. 212 F to 284 F).

In an embodiment, the methods described herein include the step of applying the coating composition described herein to the substrate. Once applied, the coating composition forms a cured coating. The dry film thickness of the cured coating is around approximately 25 μm to 250 μm (1 to 10 mil), preferably 50 μm to 200 μm (2 to 8 mil), more preferably 100 μm to 150 μm (4 to 6 mil).

The coating composition described herein may be applied to a substrate using any suitable technique, such as, for example, brushing, spraying, spin coating, roll coating, curtain coating, dipping, gravure coating, and/or the like. In an aspect, the coating composition described herein is applied by spray methods, including, for example, air spray, electrostatic spray, airless spray, air-assisted airless spray, high volume-low pressure (HVLP) spray, low volume-low pressure spray (LVLP), bell coating, and other spray techniques known to those of skill in the art.

Conventionally, when a coating composition is spray-applied to a substrate, especially when applied to a substrate present in a horizontal configuration or arrangement, a number of problems can occur that have an impact on the appearance of the coating. For example, the substrate may show solvent pop, i.e. small bubbles or craters formed on the surface of the coating as solvent evaporates from the coating. Without limiting to theory, it is believed that solvent pop is caused by the rapid cure of the coating film before all the solvent has effectively evaporated from the surface. A bubble of solvent pops, but the coating film is already at least partially cured and cannot flow and level out to a smooth appearance.

Similarly, dry spray, i.e. a coating surface defect or failure that produces a dull surface and appearance and a rough, sand-paper-like texture, is also possible when a substrate is coated by spray application. The problem usually occurs when solvent evaporates too quickly and the coating cures too quickly.

Air entrapment is another problem frequently encountered in coating applications. When a coating is applied to the surface of a substrate, air bubbles can sometimes be formed at the air-liquid interface. These bubbles can become trapped if the coating cures too quickly and cannot flow or level out to reduce bubble formation.

Surprisingly, and in contravention of knowledge in the art, the methods and compositions described herein reduce or even eliminate solvent pop, air entrapment, and dry spray or overspray. Without limiting to theory, it is believed that the compositions and methods described herein slow the cure of the coating to allow more solvent to evaporate before the coating fully cures, and allows air bubbles to disappear. Because the coating can still flow and level out when solvent or air bubbles are first formed, significantly fewer bubbles are seen on the fully cured surface. In an aspect, no solvent pop or air entrapment is observed even at dry film thicknesses of up to approximately 150 μm (about 6 mil).

Similarly, because the film does not cure too rapidly, dry spray effects are reduced or eliminated using the methods and compositions described herein.

In some embodiments, the methods described herein can be used to apply the coating composition in a wet-on-wet manner, i.e. a second coating is applied over a first coating before the first coating is fully cured or dried. The coating composition may also be applied in a wet-on-dry manner, i.e. a second coating is applied over a first coating after the first coating is fully cured or dried.

Conventionally, after a coating has been applied, the coated substrate is allowed to dry at room temperature (i.e. flash dry) prior to exposure to heat to cure the coating. This allows some solvent to evaporate prior to curing. Surprisingly, the method described herein allows the flash step to be significantly shortened or eliminated. This effectively reduces time per unit during production, and improves the throughput and productivity of the paint operation.

The compositions described herein may include a wide variety of additional ingredients. Examples of these include one or more grinding aids, processing aids, abrasion resistance aids, conductive agents, antistatic agents, coloring agents, corrosion resistance agents, sag resistance agents, thixotropes, thickeners, rheology modifying agents, antioxidants, uv stabilizers, biocides, fungicides, fillers, and mixtures and combinations thereof.

The compositions described herein may be applied to a wide variety of substrates. Exemplary substrates include metal substrates—both ferrous and non-ferrous, metal alloys, intermetallic compositions, metal-containing composites, composites, plastics, wood, porous substrates, and the like. Exemplary metal substrates include, without limitation, aluminum, steel, weathering steel, stainless steel, and the like. The compositions described herein may be applied to a wide variety of articles. Examples include commercial vehicles, trucks, construction equipment, heavy machinery, marine components, transport equipment, agricultural machinery, rail car, bridges, communication towers, machinery components, laminates, aircraft components, appliances, and the like. The coating compositions described herein can be applied to new substrates or used to refurbish old substrates. The compositions described may be useful in a variety of different end uses. Exemplary end uses include protective coatings, adhesives, sealants, caulk, and the like.

### EXAMPLES

The invention is illustrated by the following examples. It is to be understood that the particular examples, materials, amounts, and procedures are to be interpreted broadly in accordance with the scope and spirit of the inventions as set forth herein. Unless otherwise indicated, all parts and percentages are by weight and all molecular weights are weight average molecular weight. Unless otherwise specified, all chemicals used are commercially available from, for example, Sigma-Aldrich, St. Louis, Missouri.

### Test Methods

Unless indicated otherwise, the following test methods were utilized in the Examples that follow.

Pencil Hardness

The hardness of cured coatings prepared from a coating composition is tested using by the pencil method, as described in ASTM D3363 (Standard Test Method for Film Hardness by Pencil Test). Results are reported in terms of the last successful pencil prior to film rupture. Thus, for example, if a coating does not rupture when tested with a 2H pencil, but ruptures when tested with a 3H pencil, the coating is reported to have a pencil hardness of 2H.

Solvent Pop

Solvent pop is measured and reported as the maximum dry film thickness at which no bubbles or pinholes are visible to the unaided human eye on a cured coating applied to a substrate. Dry film thickness of the coating is measured using an ELCOMETER thickness gauge. The gauge includes a probe that scans a given area of a substrate surface and measures the dry film thickness without damaging the coating.

Gloss

Gloss (reported as either 20°- or 60°-gloss) is a measure of the smoothness of a coating surface. It is measured according to the method described in ASTM D523 (Standard Test Method for Specular Gloss).

Air Dry Tape Time

The dry tape time test measures the time that elapses between application of a coating composition and the point when tape can be applied without leaving a mark when the applied coating is dried at room temperature. For this test, various paint formulations are applied to test panels, each at a dry film thickness of 1.5 to 2.5 mils. SCOTCH Fine Line Tape 218 is applied at various intervals, and the time at which no marking is visible from the tape is recorded for each formulation.

Distinctness of Image

This test is used to measure the relative smoothness of a coating. For example, during overspray, it is possible that dimples or protrusions may form on a painted surface. By determining the DOI of the painted surface, it is possible to determine the degree of dimpling on the surface. For this test, an image formed of photographic patterns or rings is projected onto a painted surface from a fluorescent light box at a distance of 10 cm over the painted surface. The smallest set of rings are assigned a value of 1000, with the next larger rings getting a value of 90, and uniformly increasing larger rings have uniformly decreasing values of 80, 70, 60, 50, etc. This forms a rating scale which can be used to evaluate the distinctness of the image formed on the painted surface.

### Example 1

Preparation of Coating Compositions

The paint formulations shown in Table 1 were prepared from a single-stage urethane or polyol solution (Part A) in the presence of a catalyst (DBTDL and zinc octonoate) at the levels shown in Table 1. Part A is combined with an isocyanate solution (Part B) and at least one solvent as shown in Table 1. For the control, a standard reducing solvent is used, while formulations #2 and #4 to #5 use a 3:1 mixture of ethyl acetoacetate (EAA) and OXSOL, a commercially available version of p-chlorobenzotrifluoride. Formulation #3 uses acetylacetone (AcAc) as the solvent.

TABLE 1
Preparation of paint formulations

| Formulation | | | |
|---|---|---|---|
| No. | Part A | Part B | Solvent |
| 1 | Polyol + catalyst | Isocyanate | Standard reducing |
| (control) | | | solvent |
| 2 | Polyol + catalyst | Isocyanate | Ethyl |
| | | | acetoacetate/oxsol |
| 3 | Polyol + catalyst | Isocyanate | AcAc |
| 4 | Polyol + 2x catalyst | Isocyanate | EAA/oxsol |
| 5 | Polyol + 4x catalyst | Isocyanate | EAA/oxsol |

### Example 2

Paint Performance

Paint performance properties such as hardness, solvent pop, and gloss of the various formulations in Example 1 were determined. For these tests, test panels were sprayed and cured for 10′/8′ at 65.5° C. (150 F), and properties were measured at a DFT of 2.0 mils (approx. 50 μm) after the panels were cured and allowed to cool. Results are as shown in Table 2.

TABLE 2
Paint Performance Properties

| Formulation | | Pop, mils DFT | Gloss |
|---|---|---|---|
| No. | Hardness | (approx. DFT μm) | (20°/60°) |
| 1 (control) | 2B | 2.0 (50 μm) | 91/96 |
| 2 | 2B | >3.7 (94 μm) | 90/94 |
| 3 | — | Wrinkling above | — |
| | | 2.3 (58 μm) | |
| 4 | B | >4.3 (109 μm) | 92/96 |
| 5 | HB | >5.5 (140 μm) | 89/95 |

### Example 3

Air Dry Performance

To determine the air dry performance of the paint, various formulations from Example 1 were sprayed onto test panels at DFT of 1.5 to 2.5 mil (approx. 38 μm to 63.5 μm). Tape was applied at regular intervals and the time at which the tape no longer left a mark on the paint was recorded for each formulation. Results are as shown in Table 3.

TABLE 3
Air Dry Tape Time Results

| Formulation No. | Tape Time, Hrs |
|---|---|
| 1 (control) | >2.8 |
| 2 | 4.3 |
| 4 | 1.9 |
| 5 | 1.5 |

### Example 4

Overspray Acceptance

To determine overspray acceptance, various formulations from Example 1 were sprayed on to test panels at a DFT of 2.0 or 2.5 mil (approx. 50 μm to 63.5 μm). The painted panels were flashed for 10 minutes followed by spraying a mist of paint on the panels while standing back with a part to gun distance of approximately 3 feet. Panels were allowed to dry at room temperature, and then evaluated for gloss and distinctiveness of image. Results are shown in Table 4.

TABLE 4
Overspray Acceptance

| | DFT mil | | | |
|---|---|---|---|---|
| Formulation | (approx. | Gloss | | |
| No. | DFT μm) | (20°/60°) | DOI | Appearance |
| 1 | 2.0 (50) | 88/95 | 40 | |
| 1 | 2.5 (63.5) | 92/95 | 70 | |
| 2 | 2.0 (50) | 91/96 | 80 | |
| 2 | 2.5 (63.5) | 91/96 | 100 | |
| 4 | 2.0 (50) | 86/95 | 70 | Slight dimpling |
| 4 | 2.5 (63.5) | 88/95 | 80 | |
| 5 | 2.0 (50) | 83/95 | 40 | Slight dimpling |
| 5 | 2.5 (63.5) | 85/95 | 70 | |

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims. The invention illustratively disclosed herein suitably may be practiced, in some embodiments, in the absence of any element which is not specifically disclosed herein.

What is claimed is:

1-20. (canceled)

21. A method, comprising:
providing a first component of a coating composition;
providing a reaction mixture including
two or more solvents wherein at least one solvent is ethyl acetoacetate present in an amount of about 1 to 5 wt %, based on the total weight of the composition; and
a catalyst;
combining the first component with the reaction mixture, wherein the reaction mixture is 60 to 75% water, based on the total weight of the reaction mixture;
obtaining a two-component composition by mixing the combination of the first component and the reaction mixture with a second component; and
applying the composition to a substrate at a dry film thickness of 4 to 6 mil and drying at temperatures of 25° C. up to about 160° C. to form a cured coating that demonstrates minimal solvent pop.

22. The method of claim 21, wherein the first component includes at least one polyol.

23. The method of claim 21, wherein the second component includes at least one polyisocyanate.

24. The method of claim 21, wherein the catalyst is selected from metal, metal alkoxide, metal salts of aliphatic carboxylic acids, metal salts of alicyclic carboxylic acids, and combinations thereof.

25. The method of claim 21, wherein the catalyst is selected from tin salts, zinc salts, lithium salts, and combinations thereof.

26. The method of claim 21, wherein the catalyst is a tin compound.

27. The method of claim 21, wherein the catalyst is a zinc compound.

28. A coated article, comprising:
a substrate; and
a cured coating applied thereon, wherein the coating is obtained by the method of claim 21.

29. The article of claim 19, wherein the substrate is a metal substrate.
